(19) United States
(12) Patent Application Publication
(10) Pub. No.: US 2006/0054756 A1
(43) Pub. Date: Mar. 16, 2006

(54) Fixing device for the assembly of elements in a restricted space

(76) Inventors: Christian Mons, Paris (FR); Jean-Christophe Duclos, Arthun (FR)

Correspondence Address: McDERMOTT, WILL & EMERY, LLP, 34th Floor, 2049 Century Park East, Los Angeles, CA, 90067, US

(21) Appl. No.: 11/181,333

(22) Filed: Jul. 7, 2005

(30) Foreign Application Priority Data
Jan. 8, 2003 (FR) 0300149
Dec. 24, 2003 (WO) PCT/FR03/03899

(51) Int. Cl. F16M 11/00

(52) U.S. Cl. 248/200

(57) ABSTRACT

An element fixing device comprises a rail (1,1′,1″) with an upper wall (I1) and lateral walls (12,13). The upper wall has openings (2) with a first part which permits the passage of a screw head (5) for the fixing element and a second narrower section (22) which permits the sliding passage of a shaft (4) of a fixing screw, the edges of which serve to grip the screw head on the tightening thereof, the head of the screw being housed between the lateral walls of the rail.

This invention relates to a fixing device for the assembly of elements or accessories in a restricted space.

It is particularly but not exclusively applicable to the attachment of accessories inside or outside fixed or mobile installations and equipment such as utility vehicles running on land, sea or air.

Normally, when a wall on which elements are to be fixed is not sufficiently strong or rigid, a frame adapted to the elements to be fixed is added. Such a frame is heavy, large and is not versatile in the sense that it is specifically adapted to the elements to be fixed for which it was designed.

When this wall is reinforced or armored, it is very difficult to attach elements without affecting its strength. Armored steel cannot be welded without affecting its strength.

The purpose of this invention is to eliminate these disadvantages. This objective is achieved by providing a device for fixing elements that, according to the invention, comprises a rail including a top wall and lateral walls, the top wall being provided with openings each comprising a first part through which the fixing screw head of an element passes, and a second narrow part through which a shank of a fixing screw slides, and the edges of which are used to grip the screw head when it is being tightened, the screw head being housed between the lateral walls of the rail.

According to one feature of the invention, the width of the first part of the openings is approximately equal to the distance between the lateral walls of the rail.

Advantageously, the distance between the lateral walls of the rail is slightly greater than the width of the head of a standard screw that is hexagonal or square in shape such that the standard screw for which the head is inserted into the rail through the opening is prevented from rotating between the lateral walls of the rail.

Preferably, the section of the rail is rectangular and has a lower wall.

According to another particular feature of the invention, drillings are made in the lower wall of the rail to allow the passage of fixing elements for fixing the rail, these drillings being formed approximately vertically in line with the center of the first part of the openings.

According to yet another feature of the invention, the spacing between the upper and lower walls of the rail is slightly greater than the total height of a head of a rail fixing element and the height of a fixing screw head used to fix elements.

According to one variant embodiment of the invention, the rail is provided with a U-shaped section.

Preferably, the height of the rail is then chosen to be slightly greater than the height of the element fixing screw heads.

Advantageously, the U-shaped section of the rail is closed locally by fixing tabs fixed along the rail, each provided with at least one drilling to allow passage of the rail fixing elements.

According to one feature of the invention, the edges of the lateral walls are prolonged at right angles by bearing walls that will be applied in contact with the attachment surface of the rail and including drillings through which rail fixing elements can pass.

One preferred embodiment of the invention will be described below as a non-limitative example with reference to the attached drawings in which:

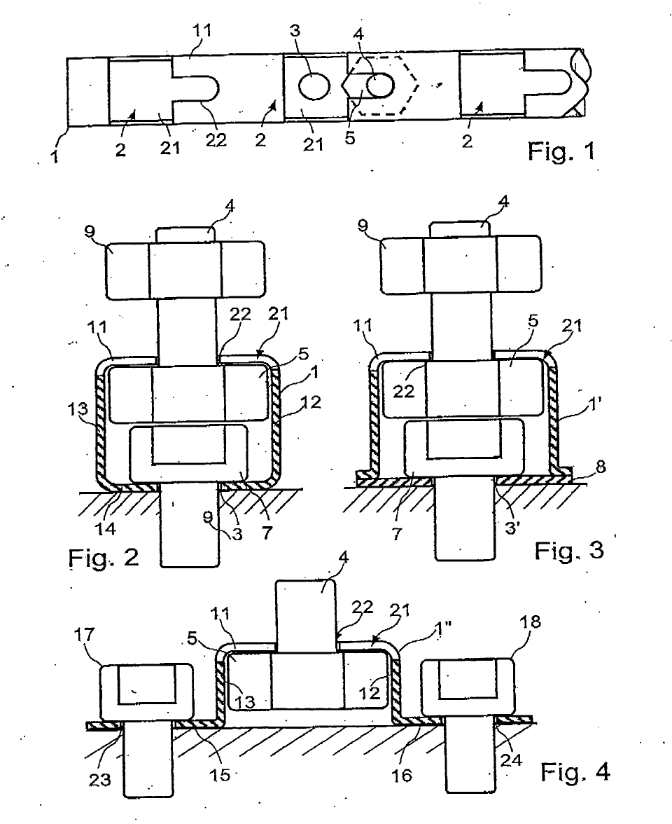

FIG. 1 diagrammatically shows a top view of the fixing device according to the invention;

FIG. 2 shows a cross-sectional view of the fixing device shown in FIG. 1;

FIGS. 3 and 4 show a cross-sectional view of two variants of the embodiment shown in FIG. 1.

In FIGS. 1 and 2, the fixing device according to the invention comprises a fixing rail 1 comprising an upper wall 11 and lateral walls 12, 13. The upper wall 11 has fixing openings 2 at a uniform spacing for fixing elements or accessories. Each of these openings 2 includes a part 21, for example a rectangular-shaped part, to enable a screw head 5 to pass through for fixing an accessory, prolonged along the axis of the rail by a narrower part 22, for example an oblong-shaped part, arranged so as to allow the screw shank 4 to pass through outside the rail by sliding along the axis of the rail once the screw head has been engaged between the lateral walls of the rail through the rectangular part 21 of the opening 2. In this position, the screw can be used to fix an element using a nut 9 engaged on the screw through the end of the shank 4, the edges of the narrower part 22 gripping the head 5 of the screw when the screw is tightened.

Advantageously, the width of the rectangular part 21 of the openings 2 is equal to approximately the distance between the lateral walls 12, 13 of the rail, such that screws with a hexagonal or square shaped head with a width slightly less than the distance between the lateral walls of the rail can be engaged in the openings 2.

In this way, when a nut 9 is tightened on the screw 4, the head 5 of the screw is gripped between the lateral walls 12, 13 of the rail.

Advantageously, the width of the rail and therefore the rectangular part 21 of the openings is chosen to correspond to the width of standard screw heads.

The spacing of openings 2 along the rail is fixed as a function of the required strength of the rail. In this respect, it should be noted that the length of the part 21 of the openings 2 may be shorter than the width of the heads 5 of the screws 4 that can be inserted in the rail, inclined along the centerline of the rail. In this way, for 8 mm screws with a hexagonal head, the pitch between two openings can be reduced to 34 mm without modifying the strength of the rail.

In the embodiment shown in FIGS. 1 and 2, the rail 1 has a rectangular shaped section with a lower wall 14. In this case, the rail may be fixed using fixing elements that are engaged in drillings 3 provided in the lower wall 14 of the rail approximately vertical in line with the center of the rectangular parts 21 of the openings 2. Screws 7 can be used as rail fixing elements, for example hexagonal socket head screws, or rivets. The rail attachment can be reinforced by using a washer in which the screw 7 is engaged before being inserted in the drilling 3.

To assure that the openings 2 used for the passage of rail fixing elements can also be used for fixing elements or accessories, the height of the rail is preferably slightly greater than the accumulated height of the head of the fixing elements (screw 7) of the rail and the height of the heads 5 of the fixing screws used to fix the elements (FIG. 2).

In the embodiment shown in FIG. 3, the rail 1′ has a U-shaped section, in other words without a lower wall. In this case, fixing spacers 8 are welded at regular intervals along the rail, so as to locally close the U-shaped section of the rail, these spacers being provided with a central drilling 3′ for the passage of fixing elements 7 of the rail. These fixing elements may also be composed of screws 7, for example cylindrical hexagonal socket head screws or rivets.

In this embodiment, the height of the rail is also chosen slightly greater than the accumulated height of the heads 5 of screws used for fixing elements and heads of rail fixing elements.

In the embodiment shown in FIG. 4, the rail 1″ has an Ω-shaped section, in other words it has lateral walls 12, 13 prolonged at a right angle by bearing walls 15, 16 that will come into contact with the attachment surface of the rail 1″. The bearing walls 15, 16 are perforated by holes 23, 24 for the passage of fixing elements such as screws 17, 18 or rivets for fixing the rail.

The bearing walls 17, 18 may also consist of fixing tabs welded to the U-shaped rail as shown in FIG. 3, so as to locally close this section.

It should be noted that in the embodiment in FIG. 4, the height of the rail may be significantly less than the height of the rails shown in FIGS. 2 and 3, since it can be reduced to the height of the heads 5 of the screws 4.

The rails shown in FIGS. 1 to 4 may easily be made for example from a plate, by cutting and then bending, stamping or rolling.

The rail shown in FIGS. 1 and 2 may also be made from a tube that is then punched. If it is manufactured from a rolled plate, the edges of the plate can be welded to obtain greater strength. It may also be made from a bent U-plate and a lower section closing plate welded onto the U section.

The fixing device that has just been described can be used on vertical, horizontal or inclined walls. It enables reliable fixing without any risk of the screws coming loose, even in an environment with strong vibrations. Therefore it is particularly suitable for use in vehicles, particularly in armored passenger compartments or vehicles with a low structural load, providing the advantage of being able to support equipment that was not planned at the time of their design.

1. Device for fixing elements, characterized in that it comprises a rail (1, 1′, 1″) comprising an upper wall (11) and lateral walls (12, 13), the upper wall having openings (2) each comprising a first part (21) enabling a screw head (5) to pass therethrough for fixing an element, and a narrower second part (22) arranged so as to allow the shank (4) of a fixing screw to pass by sliding, and the edges of which grip the head of the screw when the screw is tightened, the screw head being housed between the lateral walls of the rail.

2. Fixing device according to claim 1, characterized in that the width of the first part (21) of the openings (2) is equal to substantially the distance between the lateral walls (12, 13) of the rail.

3. Fixing device according to claim 2, characterized in that the distance between the lateral walls (12, 13) of the rail is slightly greater than the width of the head (5) of a standard screw (4) that is hexagonal or square in shape such that said standard screw for which the head is inserted into the rail through the opening (2) is prevented from rotating between the lateral walls of the rail.

4. Fixing device according to one of claims 1 to 3, characterized in that the section of the rail (1) is rectangular and has a lower wall (14).

5. Fixing device according to claim 4, characterized in that drillings (3) are made in the lower wall of the rail to allow the passage of fixing elements (7) for fixing the rail, these drillings being formed substantially vertically in line with the center of the first part (21) of the openings (2).

6. Fixing device according to claim 4 or 5, characterized in that the spacing between the upper wall (11) and the lower wall (14) of the rail (1) is slightly greater than the total height of a head of a rail fixing element (7) and the height of a fixing screw head (5) used to fix elements.

7. Fixing device according to one of claims 1 to 3, characterized in that the rail (1′, 1″) has a U-shaped section.

8. Fixing device according to claim 7, characterized in that the height of the rail (1′) is chosen to be slightly greater than the height of the element fixing screw heads (5).

9. Fixing device according to claim 7 or 8, characterized in that the U-shaped section of the rail (1′, 1″) is closed locally by fixing tabs (8) at intervals along the rail, each provided with at least one drilling (3′, 23, 24) to allow passage of the rail fixing elements (7, 17, 18).

10. Fixing device according to claim 7 or 8, characterized in that the edges of the lateral walls (12, 13) are extended at right angles by bearing walls (15, 16) that will be applied in contact with the attachment surface of the rail and including drillings (23, 24) for passing therethrough rail fixing elements (17, 18) can pass.
